(19) United States
(12) Patent Application Publication
(10) Pub. No.: US 2020/0407507 A1
(43) Pub. Date: Dec. 31, 2020

(54) POLYMER FILM, FRONT PLATE AND DISPLAY DEVICE COMPRISING SAME

(71) Applicant: SKC CO., LTD., Gyeonggi-do (KR)

(72) Inventors: Dae Seong OH, Seoul (KR); Sunhwan KIM, Incheon (KR); Han Jun KIM, Gyeonggi-do (KR); Jin Woo LEE, Seoul (KR); Sang Hun CHOI, Seoul (KR); Jung Hee KI, Gyeonggi-do (KR)

(21) Appl. No.: 16/913,006

(22) Filed: Jun. 26, 2020

(30) Foreign Application Priority Data
Jun. 28, 2019 (KR) 10-2019-0078286
Jan. 29, 2020 (KR) 10-2020-0010397
Mar. 5, 2020 (KR) 10-2020-0027586

(51) Int. Cl. C08G 73/14; C08G 73/10; C08J 5/18; C08J 3/21; C08K 3/30; B29C 41/02

(52) U.S. Cl. CPC C08G 73/14; C08G 73/1067; C08J 5/18; C08J 3/212; B29K 2077/00; B29C 41/02; C08J 2379/08; C08K 2201/005; C08K 2003/3045; C08K 3/30

(57) ABSTRACT

Embodiments relate to a polymer film for a display that maintains a clean appearance and transparency and is excellent in antiblocking properties by securing a certain range of optical slip index (OS), a process for preparing the same, and a front panel and a display device comprising the same. The polymer film comprises a polymer resin selected from the group consisting of a polyamide-based resin and a polyimide-based resin and a filler and has an optical slip index (0.5) of less than 0.5.

### TECHNICAL FIELD

Embodiments relate to a polymer film for a display that maintains a clean appearance and transparency and is excellent in antiblocking properties by securing a certain range of optical slip index, a process for preparing the same, and a front panel and a display device comprising the same.

### BACKGROUND ART OF THE INVENTION

Polyimide-based resins are excellent in resistance to friction, heat, and chemicals. Thus, they are employed in such applications as primary electrical insulation, coatings, adhesives, resins for extrusion, heat-resistant paintings, heat-resistant boards, heat-resistant adhesives, heat-resistant fibers, and heat-resistant films.

Polyimide is used in various fields. For example, polyimide is made in the form of a powder and used as a coating for a metal or a magnetic wire. It is mixed with other additives depending on the applications thereof. In addition, polyimide is used together with a fluoropolymer as a painter for decoration and corrosion prevention. It also plays a role of bonding a fluoropolymer to a metal substrate. In addition, polyimide is used to coat kitchenware, used as a membrane for gas separation by virtue of its heat resistance and chemical resistance, and used in natural gas wells for filtration of such contaminants as carbon dioxide, hydrogen sulfide, and impurities.

In recent years, polyimide has been developed in the form of a film, which is less expensive and has excellent optical, mechanical, and thermal characteristics. Such a polyimide-based film may be applied to display materials for organic light-emitting diodes (OLEDs) or liquid crystal displays (LCDs), and the like, and to antireflection films, compensation films, and retardation films if retardation properties are implemented.

Such a polymer film should be smoothly wound up without any defects such as scratches by smoothly sliding on the interface with a guide roll of high hardness that it undergoes in the production process.

In the conventional polymer films, particles such as silica have been added to impart antiblocking properties. However, since the particles are aggregated or precipitated on the surface of the film, thereby causing such a problem as an increased haze or a poor film appearance.

Accordingly, there has been a continuous demand for research on the development of a film having a clean appearance and excellent antiblocking properties without a deterioration in the optical properties and mechanical properties.

### DISCLOSURE OF THE INVENTION

### Problem to be Solved

Embodiments aim to provide a polymer film for a display that maintains a clean appearance and transparency and is excellent in antiblocking properties by securing a certain range of optical slip index, a process for preparing the same, and a front panel and a display device comprising the same.

### Solution to the Problem

The polymer film for a display according to an embodiment comprises a polymer resin selected from the group consisting of a polyamide-based resin and a polyimide-based resin and a filler and has an optical slip index (OS) represented by the following Equation 1 of less than 0.5.

$$OS = \frac{Hz}{1 \%} \times CKF \qquad [ Equation 1 ]$$

In Equation 1, Hz is the haze (%) of the polymer film, and CKF is the coefficient of kinetic friction of the polymer film.

The front panel for a display according to another embodiment comprises a polymer film and a functional layer, wherein the polymer film comprises a polymer resin selected from the group consisting of a polyamide-based resin and a polyimide-based resin and a filler and has an optical slip index (OS) represented by the above Equation 1 of less than 0.5.

The display device according to still another embodiment comprises a display unit; and a front panel disposed on the display unit, wherein the front panel comprises a polymer film, and the polymer film comprises a polymer resin selected from the group consisting of a polyamide-based resin and a polyimide-based resin and a filler and has an optical slip index (OS) represented by the above Equation 1 of less than 0.5.

The process for preparing a polymer film according to an embodiment comprises preparing a solution comprising a polymer resin selected from the group consisting of a polyamide-based resin and a polyimide-based resin in an organic solvent; adding a filler dispersion in which a filler is dispersed to the solution; charging the solution comprising the filler dispersion into a tank; extruding and casting the solution in the tank and then drying it to prepare a gel sheet; and thermally treating the gel sheet.

### Advantageous Effects of the Invention

The polymer film according to an embodiment comprises a filler having a specific refractive index in addition to a polymer resin selected from the group consisting of a polyamide-based resin and a polyimide-based resin, so that it has a specific range of an optical slip index, a maximum coefficient of static friction, and a coefficient of kinetic friction and is excellent in antiblocking properties. Thus, it is possible to secure excellent sliding performance and windability in a subsequent process.

In addition, since the polymer film according to an embodiment maintains a clean appearance and is excellent in optical properties and mechanical properties, it can be advantageously applied to a front panel and a display device.

### BRIEF DESCRIPTION OF THE DRAWINGS

FIG. 1 is a cross-sectional view of a display device according to an embodiment.

FIG. 2 is a schematic flow diagram of a process for preparing a polymer film according to an embodiment.

FIG. 3 schematically illustrates process facilities for preparing a polymer film according to an embodiment.

### DETAILED DESCRIPTION FOR CARRYING OUT THE INVENTION

Hereinafter, the embodiments will be described in detail with reference to the accompanying drawings so that those skilled in the art to which the present invention pertains may easily practice them. However, the embodiments may be implemented in many different ways and are not limited to those described herein.

Throughout the present specification, in the case where each film, window, panel, layer, or the like is mentioned to be formed “on” or “under” another film, window, panel, layer, or the like, it means not only that one element is directly formed on or under another element, but also that one element is indirectly formed on or under another element with other element(s) interposed between them. In addition, the term on or under with respect to each element may be referenced to the drawings. For the sake of description, the sizes of individual elements in the appended drawings may be exaggeratedly depicted and do not indicate the actual sizes. In addition, the same reference numerals refer to the same elements throughout the specification.

Throughout the present specification, when a part is referred to as “comprising” an element, it is understood that other elements may be comprised, rather than other elements are excluded, unless specifically stated otherwise.

In the present specification, a singular expression is interpreted to cover a singular or plural number that is interpreted in context unless otherwise specified.

In addition, all numbers and expression related to the quantities of components, reaction conditions, and the like used herein are to be understood as being modified by the term “about,” unless otherwise indicated.

The terms first, second, and the like are used herein to describe various elements, and the elements should not be limited by the terms. The terms are used only for the purpose of distinguishing one element from another.

In addition, the term “substituted” as used herein means to be substituted with at least one substituent group selected from the group consisting of deuterium, —F, —Cl, —Br, —I, a hydroxyl group, a cyano group, a nitro group, an amino group, an amidino group, a hydrazine group, a hydrazone group, an ester group, a ketone group, a carboxyl group, a substituted or unsubstituted alkyl group, a substituted or unsubstituted alkenyl group, a substituted or unsubstituted alkynyl group, a substituted or unsubstituted alkoxy group, a substituted or unsubstituted alicyclic organic group, a substituted or unsubstituted heterocyclic group, a substituted or unsubstituted aryl group, and a substituted or unsubstituted heteroaryl group. The substituent groups enumerated above may be connected to each other to form a ring.

Polymer Film

Embodiments provide a polymer film that maintains a clean appearance and transparency and is excellent in antiblocking properties.

The polymer film according to an embodiment comprises a polymer resin and a filler.

The polymer film has an optical slip index (OS) of less than 0.5.

Here, the optical slip index (OS) may be represented by the following Equation 1.

$$OS = \frac{Hz}{1 \%} \times CKF \qquad [ Equation 1 ]$$

In Equation 1, Hz is the haze (%) of the polymer film, and CKF is the coefficient of kinetic friction of the polymer film.

Specifically, the polymer film may have an optical slip index of 0.01 to less than 0.5, 0.01 to 0.45, 0.01 to 0.40, 0.01 to 0.35, 0.01 to 0.30, or 0.01 to 0.25, but it is not limited thereto.

Since the polymer film according to an embodiment has a low optical slip index, it may have enhanced slip properties without an increase in the haze. Thus, the polymer film according to an embodiment may have clear optical properties while preventing scratches caused by friction. Thus, the polymer film according to an embodiment is suitable for application to a display.

The polymer film has a maximum coefficient of static friction of 0.380 to 0.520.

Specifically, the maximum coefficient of static friction of the polymer film may be 0.400 to 0.520, 0.420 to 0.520, 0.450 to 0.520, or 0.480 to 0.520, but it is not limited thereto.

The polymer film has a coefficient of kinetic friction of 0.350 to 0.500.

Specifically, the coefficient of kinetic friction of the polymer film may be 0.365 to 0.500, 0.380 to 0.500, 0.385 to 0.500, 0.400 to 0.500, 0.430 to 0.500, or 0.460 to 0.495, but it is not limited thereto.

Here, the maximum coefficient of static friction and the coefficient of kinetic friction refer to the average values of the respective friction coefficients of the upper and lower sides of the polymer film.

That is, the maximum coefficients of static friction on both sides of the polymer film are measured, and the average value of the maximum coefficients of static friction on the upper and lower sides is then taken as the maximum coefficient of static friction of the polymer film.

In addition, the coefficients of kinetic friction on both sides of the polymer film are measured, and the average value of the coefficients of kinetic friction on the upper and lower sides is then taken as the coefficient of kinetic friction of the polymer film.

If the maximum coefficient of static friction and the coefficient of kinetic friction of the polymer film are within the above ranges, it is excellent in windability when wound up in a roll shape and in sliding performance in the preparation process. Since such antiblocking properties are excellent during sliding and winding, no defects such as scratches or wrinkles are generated.

Specifically, if the friction coefficients are less than the above ranges, the blocking properties of the film surface are too low to thereby relatively increase the slip properties, so that there may arise a problem that the film deviates from the driving path while sliding along the guide roll or that its winding is not properly performed when wound in a roll shape. In addition, if the friction coefficients exceed the above ranges, the blocking properties of the film surface are too high to thereby relatively reduce the slip properties, so that there may arise a problem that the film is not sliding well due to the friction with the guide roll and that the film roll is crumpled when the film is wound in a roll shape.

The polymer film has a haze of % or less.

Specifically, the haze of the polymer film may be 0.8% or less, 0.6% or less, or 0.5% or less, but it is not limited thereto.

If the haze of the polymer film exceeds the above range, the transparency is deteriorated, making it unsuitable for application to a front panel or a display device. In addition, since the screen appears bluish and dark, there arises a problem that more power is consumed to maintain a brighter screen to compensate for this.

The polymer film according to an embodiment has an n₁₂ according to the following Equation 2 of 3 or less.

$${n}_{12} = \frac{\vert n 1 - n 2 \vert}{n 1} \times 100 \qquad [ Equation 2 ]$$

In Equation 2, n₁ is the refractive index of the polymer film, and n₂ is the refractive index of the filler.

Specifically, the n₁₂ may be 2.8 or less, 2.5 or less, 0.2 to 3, 0.2 to 2.5, 0.2 to 2.0, 0.2 to 1.5, 0.4 to 1.5, or 0.6 to 1.3, but it is not limited thereto.

Since the polymer film according to an embodiment has an n₁₂ according to the above Equation 2 that satisfies the above range, it may have enhanced slip properties without an increase in the haze. Thus, the polymer film according to an embodiment may have clear optical properties while preventing scratches caused by friction. Thus, the polymer film according to an embodiment is suitable for application to a display.

If the n₁₂ of the polymer film exceeds the above range, the haze increases and the mechanical properties are deteriorated while the filler aggregates, in particular, resulting in a poor film appearance.

The polymer film according to an embodiment has a Δn according to the following Equation 3 of 0.1 or less.

Δn=|n₁−n₂| [Equation 3]

In Equation 3, n₁ is the refractive index of the polymer film, and n₂ is the refractive index of the filler.

Specifically, the Δn may be 0.08 or less, 0.06 or less, 0.05 or less, 0.04 or less, 0.03 or less, or 0.02 or less, but it is not limited thereto.

If the Δn of the polymer film exceeds the above range, there may arise a problem that the filler is visually noticeable on the film or that the filler is precipitated on the film surface, thereby increasing the haze.

The polymer film according to an embodiment has a refractive index (n₁) of 1.55 to 1.75. Specifically, the refractive index (n₁) of the polymer film may be 1.55 to 1.70, 1.58 to 1.68, 1.60 to 1.68, 1.62 to 1.66, or 1.62 to 1.65, but it is not limited thereto.

In addition, the polymer film comprises a filler in addition to the polymer resin, and the filler has a refractive index (n₂) of 1.55 to 1.75. Specifically, the refractive index (n₂) of the filler may be 1.60 to 1.75, 1.60 to 1.70, 1.60 to 1.68, or 1.62 to 1.65, but it is not limited thereto.

The polymer film according to still another embodiment has an NC according to the following Equation 4 of 5 to 150.

$$NC = ( \vert {n}_{1} - {n}_{2} \vert + 0.01 ) \times \frac{FC}{1 ppm} \qquad [ Equation 4 ]$$

In Equation 4, n₁ is the refractive index of the polymer film, n₂ is the refractive index of the filler, and FC is the content (ppm) of the filler based on the total weight of the solids content of the polymer resin.

Specifically, the NC may be 5 to 130, 5 to 120, 5 to 100, 5 to 80, 10 to 80, 10 to 70, or 10 to 60, but it is not limited thereto.

If the NC of the polymer film exceeds the above range, the filler may be precipitated on the film surface as the filler aggregates, resulting in a poor film appearance. In addition, the NC of the polymer film is less than the above range, the maximum coefficient of static friction and the coefficient of kinetic friction are increased, which causes blocking, so that defects such as scratches may be generated during winding or in a subsequent process.

The filler contained in the polymer film according to an embodiment has an average particle diameter of 110 nm to 180 nm.

Specifically, the average particle diameter of the filler may be 110 nm to 160 nm, 120 nm to 160 nm, or 130 nm to 150 nm, but it is not limited thereto.

If the average particle diameter of the filler is within the above range, the optical properties are not deteriorated even when a relatively large amount thereof is employed as compared with other inorganic fillers. Thus, it is possible to obtain a film having a low maximum coefficient of static friction and a low coefficient of kinetic friction.

The filler may be barium sulfate.

The barium sulfate may be employed in the form of particles. In addition, the surface of barium sulfate particles is not specially treated with coating, and they may be uniformly dispersed in the entire film.

Since the polymer film comprises barium sulfate, the film can enhance the antiblocking properties without a deterioration in the optical properties, and it is excellent in mechanical properties as well.

The content of the filler may be 500 ppm to 2,000 ppm based on the total weight of the solids content of the polymer resin.

If the content of the filler exceeds the above range, the haze of the film rapidly increases, and the filler may aggregate with each other on the surface of the film, so that a feeling of foreign matter may be visually observed. Such a film may appear to have improved antiblocking properties and winderability due to a low friction coefficient, but it may be unsuitable for application in a subsequent process due to such defects as scratches and wrinkles.

On the other hand, if the content of the filler is less than the above range, the maximum coefficient of static friction and the coefficient of kinetic friction rapidly increase, which may cause a problem in sliding in the preparation process, and the windability is also deteriorated.

The polymer film according to an embodiment comprises a polymer resin.

The polymer resin may be selected from the group consisting of a polyamide-based resin and a polyimide-based resin.

The polyamide-based resin is a resin that contains an amide repeat unit. The polyimide-based resin is a resin that contains an imide repeat unit. In addition, a resin comprising the imide repeat unit and the amide repeat unit may be referred to as the polyamide-based resin and may be referred to as the polyimide-based resin.

For example, the polymer resin may be a resin comprising a polyamide-based resin, a resin comprising a polyimide-based resin, or a resin comprising both a polyamide-based resin and a polyimide-based resin.

The polymer resin may be prepared by polymerizing a diamine compound, a dianhydride compound, and optionally a dicarbonyl compound.

The polymer resin may be prepared by simultaneously or sequentially reacting reactants that comprise a diamine compound and a dianhydride compound. Specifically, the polymer resin is prepared by polymerizing a diamine compound and a dianhydride compound.

Alternatively, the polymer resin may be prepared by polymerizing a diamine compound, a dianhydride compound, and a dicarbonyl compound. Here, the polymer resin may comprise an imide repeat unit derived from the polymerization of the diamine compound and the dianhydride compound and an amide repeat unit derived from the polymerization of the diamine compound and the dicarbonyl compound.

The polymer film according to an embodiment comprises a polymer resin, wherein the polymer resin is prepared by polymerizing a diamine compound, a dianhydride compound, and a dicarbonyl compound, and the molar ratio of the dianhydride compound and the dicarbonyl compound is 2:98 to 15:85.

In another embodiment, the molar ratio of the dianhydride compound and the dicarbonyl compound may be 3:97 to 15:85, 5:95 to 15:85, or 7:93 to 15:85, but it is not limited thereto.

If the molar ratio of the dianhydride compound and the dicarbonyl compound is within the above range, a film having excellent optical properties, mechanical properties, and antiblocking properties can be obtained. For example, if the molar ratio of the dicarbonyl compound is relatively large, the mechanical strength such as modulus may be deteriorated.

The diamine compound is a compound that forms an imide bond with the dianhydride compound and forms an amide bond with the dicarbonyl compound, to thereby form a copolymer.

The diamine compound is not particularly limited, but it may be, for example, an aromatic diamine compound that contains an aromatic structure. For example, the diamine compound may be a compound represented by the following Formula 1.

H₂N-(E)ₑNH₂ [Formula I]

In Formula 1,

E may be selected from a substituted or unsubstituted divalent C₆-C₃₀ aliphatic cyclic group, a substituted or unsubstituted divalent C₄-C₃₀ heteroaliphatic cyclic group, a substituted or unsubstituted divalent C₆-C₃₀ aromatic cyclic group, a substituted or unsubstituted divalent C₄-C₃₀ heteroaromatic cyclic group, a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—.

e is selected from integers of 1 to 5. When e is 2 or more, the Es may be the same as, or different from, each other.

(E)ₑ in Formula 1 may be selected from the groups represented by the following Formulae 1-1a to 1-14a, but it is not limited thereto.

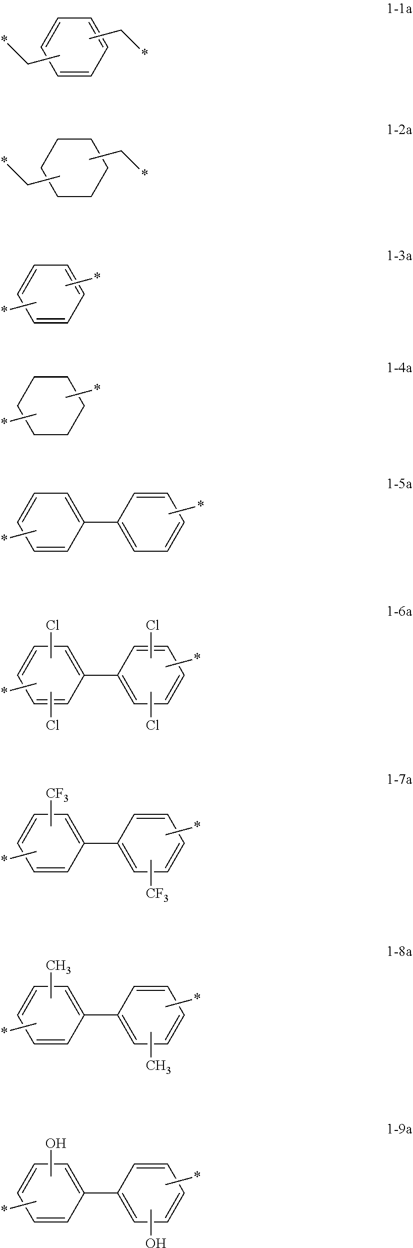

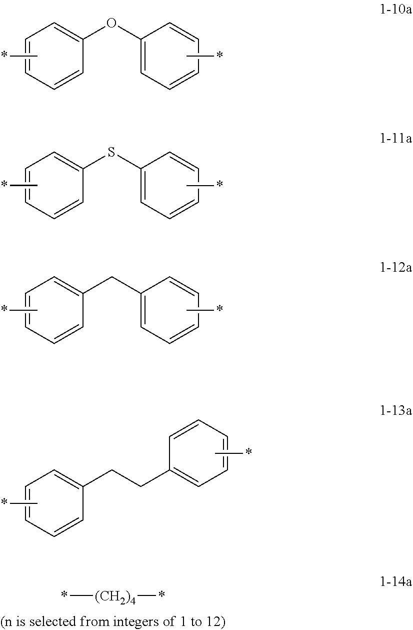

Specifically, (E), in Formula 1 may be selected from the groups represented by the following Formulae 1-1b to 1-13b, but it is not limited thereto.

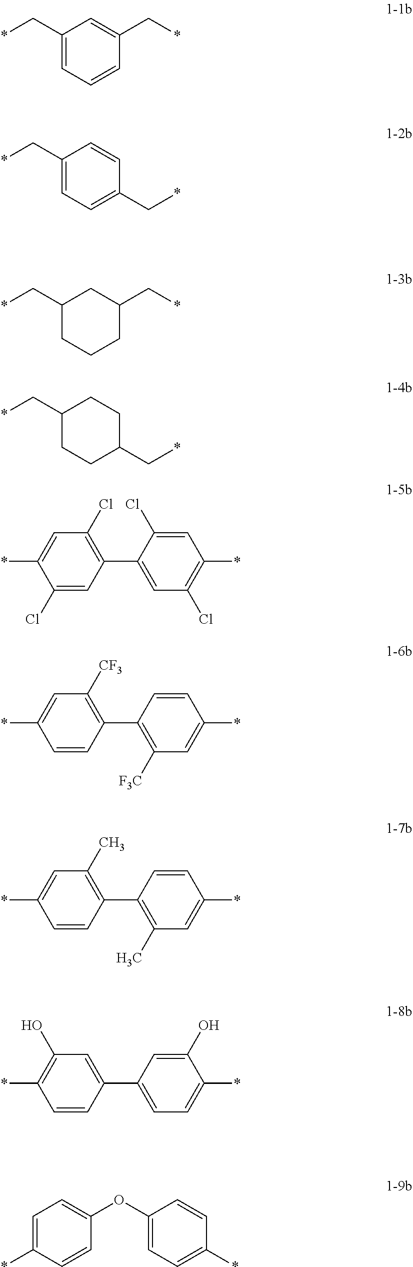

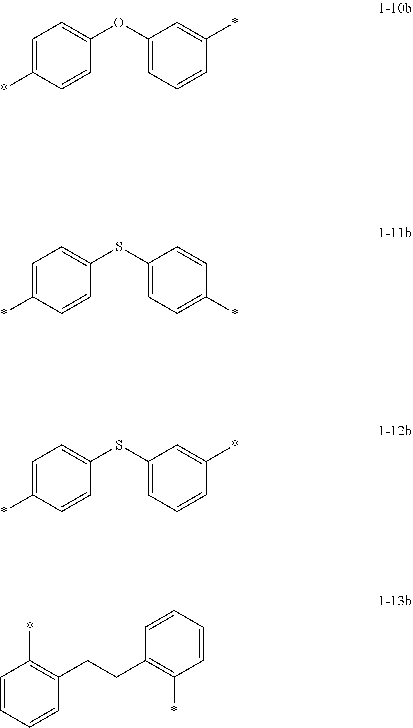 [SMILES: *c1ccc(Oc2cccc(*)c2)cc1 ; *c1ccc(Sc2ccc(*)cc2)cc1 ; *c1ccc(Sc2cccc(*)c2)cc1 ; *c1ccccc1CCc1ccccc1*]

More specifically, (E)ₑ in Formula 1 may be the group represented by the above Formula 1-6b or the group represented by the above Formula 1-9 h.

In an embodiment, the diamine compound may comprise a compound having a fluorine-containing substituent or a compound having an ether group (—O—). In such event, the fluorine-containing substituent may be a fluorinated hydrocarbon group and specifically may be a trifluoromethyl group. But it is not limited thereto.

In another embodiment, one kind of diamine compound may be used as the diamine compound. That is, the diamine compound may be composed of a single component.

For example, the diamine compound may comprise 2,2′-bis(trifluoromethyl)-4,4′-diaminobiphenyl (TFDB) represented by the following formula, but it is not limited thereto.

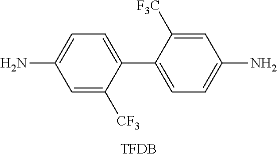

The dianhydride compound has a low birefringence value, so that it can contribute to enhancements in the optical properties such as transmittance of a film that comprises the polyimide-based resin. The polyimide-based resin refers to a resin that contains an imide repeat unit.

The dianhydride compound is not particularly limited, but it may be, for example, an aromatic dianhydride compound that contains an aromatic structure.

For example, the aromatic dianhydride compound may be a compound represented by the following Formula 2.

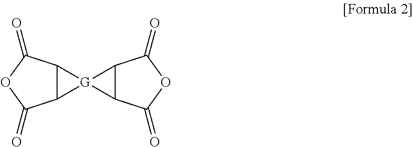

In Formula 2, G may be bonded by a bonding group selected from a substituted or unsubstituted tetravalent C₆-C₃₀ aliphatic cyclic group, a substituted or unsubstituted tetravalent C₄-C₃₀ heteroaliphatic cyclic group, a substituted or unsubstituted tetravalent C₆-C₃₀ aromatic cyclic group, a substituted or unsubstituted tetravalent C₄-C₃₀ heteroaromatic cyclic group, wherein the aliphatic cyclic group, the heteroaliphatic cyclic group, the aromatic cyclic group, or the heteroaromatic cyclic group may be present alone or may be bonded to each other to form a condensed ring, a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—.

G in Formula 2 may be selected from the groups represented by the following Formulae 2-1a to 2-9a, but it is not limited thereto.

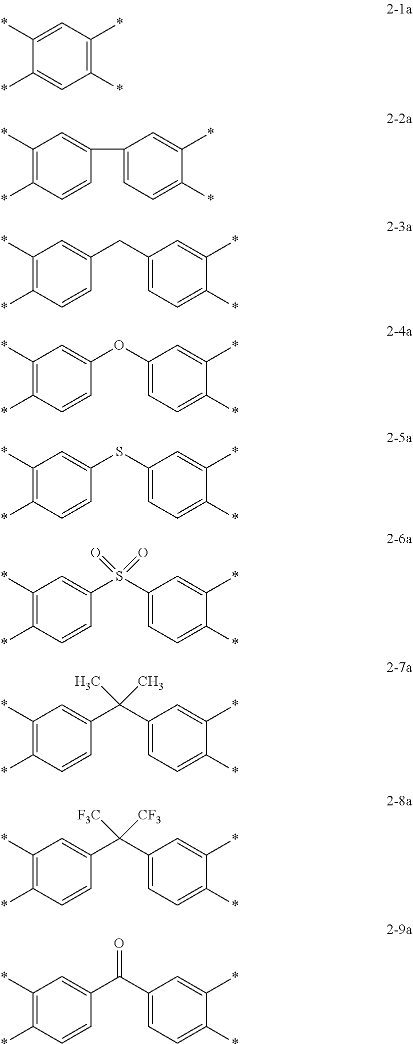

For example, G in Formula 2 may be the group represented by the above Formula 2-2a, the group represented by the above Formula 2-8a, or the group represented by the above Formula 2-9a.

In an embodiment, the dianhydride compound may comprise a compound having a fluorine-containing substituent. In such event, the fluorine-containing substituent may be a fluorinated hydrocarbon group and specifically may be a trifluoromethyl group. But it is not limited thereto.

In another embodiment, the dianhydride compound may be composed of a single component or a mixture of two components.

For example, the dianhydride compound may comprise 2,2′-bis-(3,4-dicarboxyphenyl)hexafluoropropane dianhydride (6FDA) represented by the following formula, but it is not limited thereto.

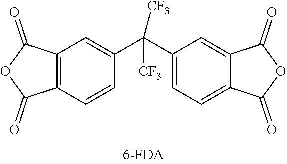 [SMILES: O=C1OC(=O)c2cc(C(c3ccc4c(c3)C(=O)OC4=O)(C(F)(F)F)C(F)(F)F)ccc21]

The diamine compound and the dianhydride compound may be polymerized to form a polyamic acid.

Subsequently, the polyamic acid may be converted to a polyimide through a dehydration reaction, and the polyimide comprises an imide repeat unit.

The polyimide may form a repeat unit represented by the following Formula A.

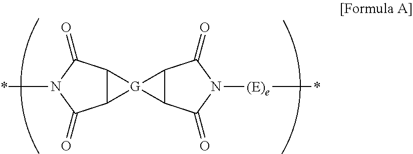

In Formula A, E, G, and e are as described above.

For example, the polyimide may comprise a repeat unit represented by the following Formula A-1, but it is not limited thereto.

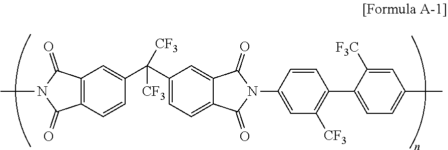

In Formula A-1, n is an integer of 1 to 400.

The dicarbonyl compound is not particularly limited, but it may be, for example, a compound represented by the following Formula 3.

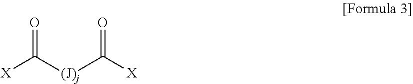

In Formula 3,

J may be selected from a substituted or unsubstituted divalent C₆-C₃₀ aliphatic cyclic group, a substituted or unsubstituted divalent C₄-C₃₀ heteroaliphatic cyclic group, a substituted or unsubstituted divalent C₆-C₃₀ aromatic cyclic group, a substituted or unsubstituted divalent C₄-C₃₀ heteroaromatic cyclic group, a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—.

j is selected from integers of 1 to 5. When j is 2 or more, the Js may be the same as, or different from, each other.

X is a halogen atom. Specifically, X may be F, Cl, Br, I, or the like. More specifically, X may be Cl, but it is not limited thereto.

(J) in Formula 3 may be selected from the groups represented by the following Formulae 3-1a to 3-14a, but it is not limited thereto.

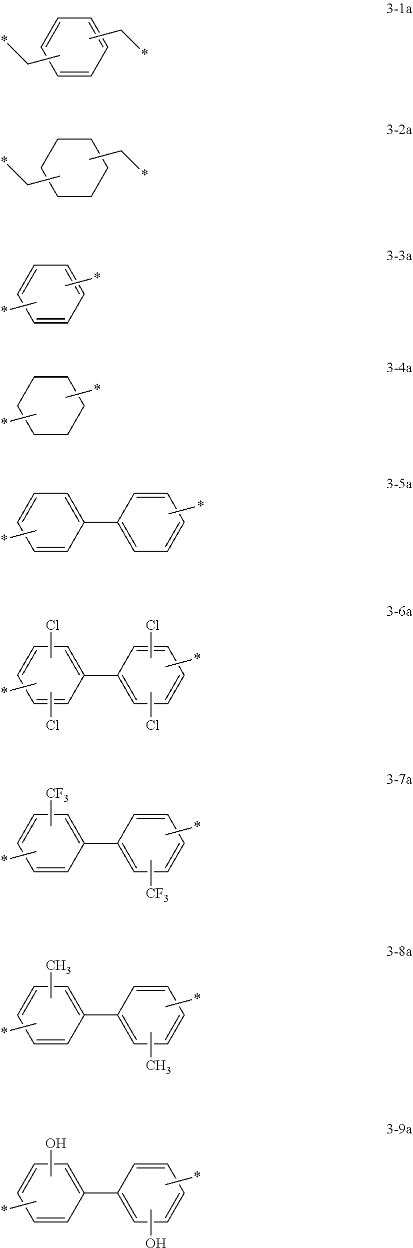

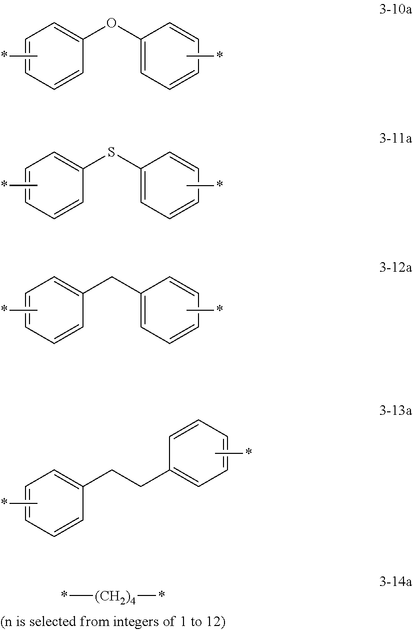

Specifically, (J) in Formula 3 may be selected from the groups represented by the following Formulae 3-1b to 3-8b, but it is not limited thereto.

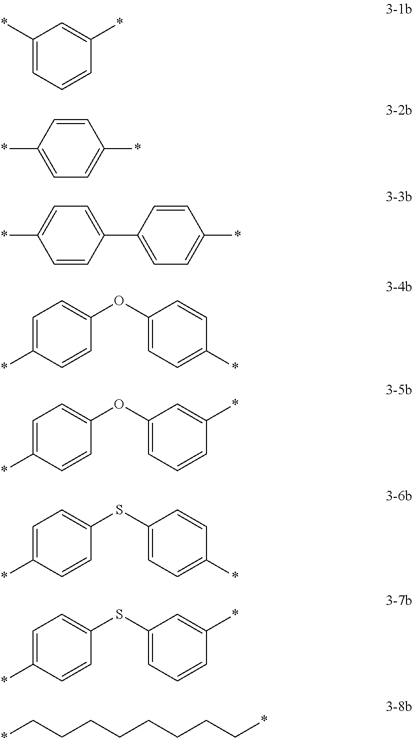

More specifically, (J) in Formula 3 may be the group represented by the above Formula 3-1b, the group represented by the above Formula 3-2b, the group represented by the above Formula 3-3b, or the group represented by the above Formula 3-8b.

In another embodiment, the dicarbonyl compound may be an aromatic dicarbonyl compound that contains an aromatic structure.

The dicarbonyl compound may comprise terephthaloyl chloride (TPC), 1,1′-biphenyl-4,4′-dicarbonyl dichloride (BPDC), isophthaloyl chloride (IPC), as represented by the following formulae, or a combination thereof. But it is not limited thereto.

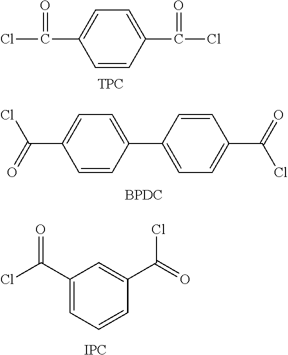

The diamine compound and the dicarbonyl compound may be polymerized to form a repeat unit represented b the following Formula B.

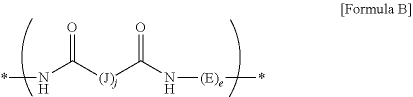

In Formula B, E, J, e, and j are as described above.

For example, the diamine compound and the dicarbonyl compound may be polymerized to form amide repeat units represented by the following Formulae B-1 and B-2.

Alternatively, the diamine compound and the dicarbonyl compound may be polymerized to form amide repeat units represented by the following Formulae B-2 and B-3.

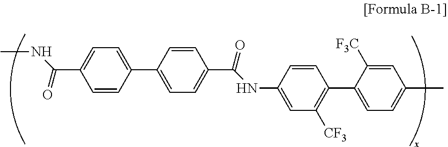

In Formula B-1, x is an integer of 1 to 400.

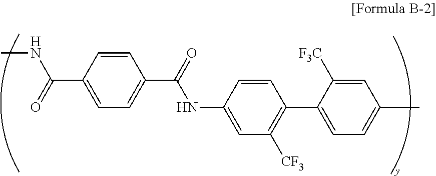

In Formula B-2, y is an integer of 1 to 400.

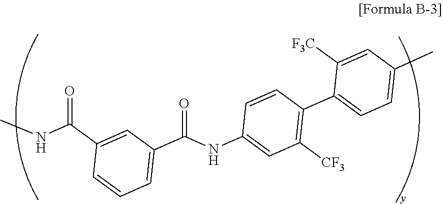

In Formula B-3, y is an integer of 1 to 400.

According to an embodiment, the polymer resin may comprise an imide-based repeat unit and an amide-based repeat unit at a molar ratio of 2:98 to 15:85. Specifically, the polymer resin may comprise an imide-based repeat unit and an amide-based repeat unit at a molar ratio of 3:97 to 15:85, 5:95 to 15:85, or 7:93 to 15:85, but it is not limited thereto.

If the molar ratio of the imide repeat unit and the amide repeat unit is within the above range, a film having excellent antiblocking properties, as well as excellent optical characteristics and mechanical characteristics, can be obtained. On the other hand, if the molar ratio of the amide repeat unit exceeds the above range, the mechanical properties such as modulus may be deteriorated.

According to an embodiment, the polymer resin may comprise a repeat unit represented by the following Formula A and a repeat unit represented by the following Formula B:

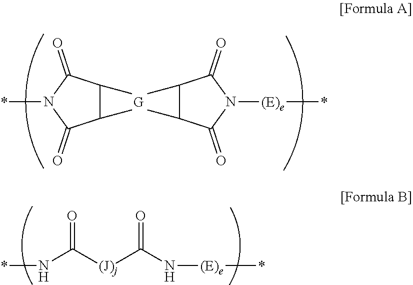

In Formulae A and B,

E and J are each independently selected from a substituted or unsubstituted divalent C₆-C₃₀ aliphatic cyclic group, a substituted or unsubstituted divalent C₄-C₃₀ heteroaliphatic cyclic group, a substituted or unsubstituted divalent C₆-C₃₀ aromatic cyclic group, a substituted or unsubstituted divalent C₄-C₃₀ heteroaromatic cyclic group, a substituted or unsubstituted C₁-C₃₀ alkylene group, a substituted or unsubstituted C₂-C₃ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—,

e and j are each independently selected from integers of 1 to 5,

when e is 2 or more, then the two or more Es are the same as, or different from, each other,

when j is 2 or more, then the two or more Js are the same as, or different from, each other,

G may be bonded by a bonding group selected from a substituted or unsubstituted tetravalent C₆-C₃₀ aliphatic cyclic group, a substituted or unsubstituted tetravalent C₄-C₃₀ heteroaliphatic cyclic group, a substituted or unsubstituted tetravalent C₆-C₃₀ aromatic cyclic group, a substituted or unsubstituted tetravalent C₄-C₃₀ heteroaromatic cyclic group, wherein the aliphatic cyclic group, the heteroaliphatic cyclic group, the aromatic cyclic group, or the heteroaromatic cyclic group may be present alone or may be bonded to each other to form a condensed ring, a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—.

In the polymer resin, the molar ratio of the repeat unit represented by the above Formula A and the repeat unit represented by the above Formula B is 2:98 to 15:85.

Specifically, the molar ratio of the repeat unit represented by the above Formula A to the repeat unit represented by the above Formula B may be 3:97 to 15:85, 5:95 to 15:85, or 7:93 to 15:85, but it is not limited thereto.

The polymer film may have a transmittance of 80% or more. For example, the transmittance may be 85% or more, 88% or more, 89% or more, 80% to 99%, 85% to 99%, or 88% to 99%.

The polymer film has a yellow index of 5 or less. For example, the yellow index may be 4 or less, 3.5 or less, or 3 or less, but it is not limited thereto.

The polymer film has a modulus of 5.0 GPa or more. Specifically, the modulus may be 5.5 GPa or more, 6.0 GPa or more, or 6.2 GPa or more, but it is not limited thereto.

The polymer film has a compressive strength is 0.3 kgf/μm or more. Specifically, the compressive strength may be 0.4 kgf/sm or more, 0.45 kgf/sm or more, or 0.48 kgf/sm or more, but it is not limited thereto.

When the polymer film is perforated at a speed of 10 mm/min using a 2.5-mm spherical tip in a UTM compression mode, the maximum diameter (mm) of perforation including a crack is 65 mm or less. Specifically, the maximum diameter of perforation may be 5 to 60 mm, 10 to 60 mm, 15 to 60 mm, 20 to 60 mm, 25 to 60 mm, or 25 to 58 mm, but it is not limited thereto.

The polymer film has a surface hardness of HB or higher. Specifically, the surface hardness may be H or higher, or 2H or higher, but it is not limited thereto.

The polymer film has a tensile strength of 14 kgf/mm² or more. Specifically, the tensile strength may be 16 kgf/mm² or more, 18 kgf/mm² or more, 20 kgf/mm² or more, 21 kgf/mm² or more, or 22 kgf/mm² or more, but it is not limited thereto.

The polymer film has an elongation of 13% or more. Specifically, the elongation may be 15% or more, 16% or more, 17% or more, or 17.5% or more, but it is not limited thereto.

The polymer film according to an embodiment can secure excellent optical and mechanical properties such as low haze, low yellow index, and high modulus, as well as excellent antiblocking properties attributable to a specific range of an optical slip index, a maximum coefficient of static friction, and a coefficient of kinetic friction. Thus, it is possible to provide a film that maintains a clean appearance and transparency and is excellent in antiblocking properties without a deterioration in the mechanical properties.

The physical properties of the polymer film as described above are based on a thickness of 40 μm to 60 μm or a thickness of 70 μm to 90 μm. For example, the physical properties of the polymer film are based on a thickness of 50 μm or a thickness of 80 μm.

The features on the components and properties of the polymer film as described above may be combined with each other.

In addition, the properties of the polymer film as described above are the results materialized by combinations of the chemical and physical properties of the components, which constitute the polymer film, along with the conditions in each step of the process for preparing the polymer film as described below.

Front Panel

The front panel according to an embodiment comprises a polymer film and a functional layer.

The front panel may be a front panel for a display.

The polymer film comprises a polymer resin selected from the group consisting of a polyamide-based resin and a polyimide-based resin and a filler.

In addition, the polymer film has an optical slip index (OS) represented by the above Equation 1 of less than 0.5.

The details on the polymer film are as described above.

The front panel may be advantageously applied to a display device.

Since the polymer film has excellent antiblocking properties and a clean appearance and transparency, it can be advantageously applied to a front panel for a display.

Display Device

The display device according to an embodiment comprises a display unit; and a front panel disposed on the display unit, wherein the front panel comprises a polymer film.

In addition, the polymer film comprises a polymer resin selected from the group consisting of a polyamide-based resin and a polyimide-based resin and a filler.

Further, the polymer film has an optical slip index (OS) represented by the above Equation 1 of less than 0.5.

The details on the polymer film and the front panel are as described above.

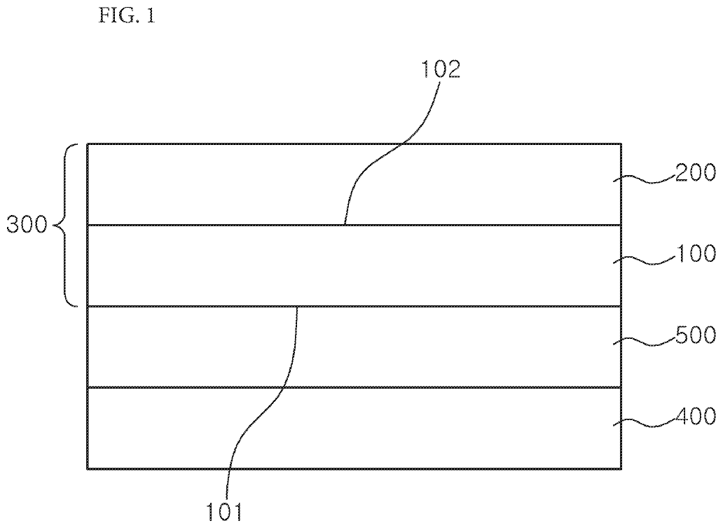

FIG. 1 is a cross-sectional view of a display device according to an embodiment.

Specifically, FIG. 1 illustrates a display device, which comprises a display unit (400) and a front panel (300) disposed on the display unit (400), wherein the front panel comprises a polymer film (100) having a first side (101) and a second side (102) and a functional layer (200), and an adhesive layer (500) is interposed between the display unit (400) and the front panel (300).

The display unit (400) is for displaying an image, and it may have flexible characteristics.

The display unit (400) may be a display panel for displaying an image. For example, it may be a liquid crystal display panel or an organic electroluminescent display panel. The organic electroluminescent display panel may comprise a front polarizing plate and an organic EL panel.

The front polarizing plate may be disposed on the front side of the organic EL panel. Specifically, the front polarizing plate may be attached to the side on which an image is displayed in the organic EL panel.

The organic EL panel displays an image by self-emission of a pixel unit. The organic EL panel may comprise an organic EL substrate and a driving substrate. The organic EL substrate may comprise a plurality of organic electroluminescent units, each of which corresponds to a pixel. Specifically, it may comprise a cathode, an electron transport layer, a light-emitting layer, a hole transport layer, and an anode. The driving substrate is operatively coupled to the organic EL substrate. That is, the driving substrate may be coupled to the organic EL substrate so as to apply a driving signal such as a driving current, so that the driving substrate can drive the organic EL substrate by applying a current to the respective organic electroluminescent units.

In addition, an adhesive layer (500) may be interposed between the display unit (400) and the front panel (300). The adhesive layer may be an optically transparent adhesive layer, but it is not particularly limited.

The front panel (300) is disposed on the display unit (400). The front panel is located at the outermost position of the display device to thereby protect the display unit.

The front panel (300) may comprise a polymer film and a functional layer. The functional layer may be at least one selected from the group consisting of a hard coating, a reflectance reducing layer, an antifouling layer, and an antiglare layer. The functional layer may be coated on at least one side of the polymer film.

Process for Preparing a Polymer Film

An embodiment provides a process for preparing a polymer film.

The process for preparing a polymer film according to an embodiment comprises preparing a solution comprising a polymer resin selected from the group consisting of a polyamide-based resin and a polyimide-based resin in an organic solvent; adding a filler dispersion in which a filler is dispersed to the solution; charging the solution comprising the filler dispersion into a tank; extruding and casting the solution in the tank and then drying it to prepare a gel sheet; and thermally treating the gel sheet.

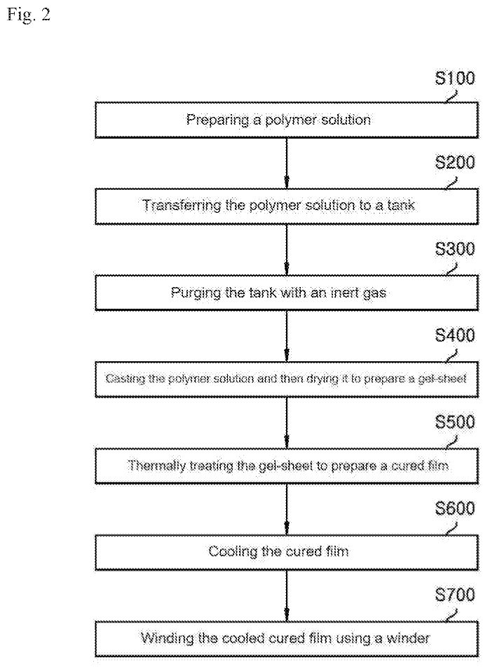

Referring to FIG. 2, the process for preparing a polymer film comprises simultaneously or sequentially mixing a diamine compound, a dianhydride compound, and optionally a dicarbonyl compound in an organic solvent in a polymerization apparatus, and reacting the mixture to prepare a polymer solution (S100); transferring the polymer solution to a tank (S200); purging with an inert gas (S300); casting the polymer solution in the tank onto a belt and then drying it to prepare a gel-sheet (S400); thermally treating the gel-sheet while it is moved to prepare a cured film (S500); cooling the cured film while it is moved (S600); and winding the cooled cured film using a winder (S700).

The polymer film comprises a polymer resin, as a main component, selected from the group consisting of a polyamide-based resin and a polyimide-based resin.

In the process for preparing a polymer film, a polymer solution for preparing the polymer resin is prepared by simultaneously or sequentially mixing a diamine compound and a dicarbonyl compound, or a diamine compound, a dianhydride compound, and a dicarbonyl compound, in an organic solvent in a polymerization apparatus, and reacting the mixture (S100).

In an embodiment, the polymer solution may be prepared by simultaneously mixing and reacting a diamine compound, a dianhydride compound, and optionally a dicarbonyl compound in an organic solvent. For example, the polymer solution may be prepared by simultaneously mixing and reacting a diamine compound, a dianhydride compound, and a dicarbonyl compound in an organic solvent.

In another embodiment, the step of preparing the polymer solution may comprise mixing and reacting the diamine compound and the dianhydride compound in a solvent to produce a polyamic acid solution; and subjecting the polyamic acid solution to dehydration to produce a polyimide (PI) solution.

In still another embodiment, the step of preparing the polymer solution may comprise first mixing and reacting the diamine compound and the dianhydride compound in a solvent to produce a polyamic acid (PAA) solution; and second mixing and reacting the polyamic acid (PAA) solution and the dicarbonyl compound to form an amide bond and an imide bond. The polyamic acid solution is a solution that comprises a polyamic acid.

Alternatively, the step of preparing the polymer solution may comprise first mixing and reacting the diamine compound and the dianhydride compound in a solvent to produce a polyamic acid solution; subjecting the polyamic acid solution to dehydration to produce a polyimide (PI) solution; and second mixing and reacting the polyimide (PI) solution and the dicarbonyl compound to further form an amide bond. The polyimide solution is a solution that comprises a polymer having an imide repeat unit.

In still another embodiment, the step of preparing the polymer solution may comprise first mixing and reacting the diamine compound and the dicarbonyl compound in a solvent to produce a polyamide (PA) solution; and second mixing and reacting the polyamide (PA) solution and the dianhydride compound to further form an imide bond. The polyamide solution is a solution that comprises a polymer having an amide repeat unit.

The polymer solution thus prepared may be a solution that comprises a polymer containing at least one selected from the group consisting of a polyamic acid (PAA) repeat unit, a polyamide (PA) repeat unit, and a polyimide (PI) repeat unit.

For example, the polymer contained in the polymer solution may comprise an imide repeat unit derived from the polymerization of the diamine compound and the dianhydride compound.

Alternatively, the polymer contained in the polymer solution may comprise an imide repeat unit derived from the polymerization of the diamine compound and the dianhydride compound and an amide repeat unit derived from the polymerization of the diamine compound and the dicarbonyl compound.

The content of solids contained in the polymer solution may be 10% by weight to 30% by weight. Alternatively, the content of solids contained in the polymer solution may be 15% by weight to 25% by weight, but it is not limited thereto.

If the content of solids contained in the polymer solution is within the above range, a polymer film can be effectively produced in the extrusion and casting steps. In addition, the polymer film thus prepared maintains a clean appearance and transparency while securing specific ranges of an optical slip index, a maximum static friction coefficient, and a coefficient of kinetic friction, resulting in excellent antiblocking properties.

In an embodiment, the step of preparing the polymer solution may further comprise introducing a catalyst.

Here, the catalyst may comprise at least one selected from the group consisting of beta picoline, acetic anhydride, isoquinoline (IQ), and pyridine-based compounds, but it is not limited thereto.

The catalyst may be added in an amount of 0.01 to 0.4 molar equivalent based on 1 mole of the polyamic acid, but it is not limited thereto.

The further addition of the catalyst may expedite the reaction rate and enhance the chemical bonding force between the repeat unit structures or that within the repeat unit structures.

In another embodiment, the step of preparing the polymer solution may further comprise adjusting the viscosity of the polymer solution.

Specifically, the step of preparing the polymer solution may comprise (a) simultaneously or sequentially mixing and reacting a diamine compound, a dianhydride compound, and optionally a dicarbonyl compound in an organic solvent to prepare a first polymer solution; (b) measuring the viscosity of the first polymer solution and evaluating whether the target viscosity has been reached; and (c) if the viscosity of the first polymer solution does not reach the target viscosity, further adding the dianhydride compound or the dicarbonyl compound to prepare a second polymer solution having the target viscosity.

The target viscosity may be 100,000 cps to 500,000 cps at room temperature. Specifically, the target viscosity may be 100,000 cps to 400,000 cps, 100,000 cps to 350,000 cps, 100,000 cps to 300,000 cps, 150,000 cps to 300,000 cps, or 150,000 cps to 250,000 cps, but it is not limited thereto.

In the steps of preparing the first polymer solution and the second polymer solution, the polymer solutions have viscosities different from each other. For example, the second polymer solution has a viscosity higher than that of the first polymer solution.

In the steps of preparing the first polymer solution and the second polymer solution, the stirring speeds are different from each other. For example, the stirring speed when the first polymer solution is prepared is faster than the stirring speed when the second polymer solution is prepared.

In still another embodiment, the step of preparing the polymer solution may further comprise adjusting the pH of the polymer solution. In this step, the pH of the polymer solution may be adjusted to 4 to 7, for example, 4.5 to 7, but it is not limited thereto.

The pH of the polymer solution may be adjusted by adding a pH adjusting agent. The pH adjusting agent is not particularly limited and may include, for example, amine-based compounds such as alkoxyamine, alkylamine, and alkanolamine.

If the pH of the polymer solution is adjusted to the above range, it is possible to prevent the damage to the equipment in the subsequent process, to prevent the occurrence of defects in the film produced from the polymer solution, and to achieve the desired optical properties and mechanical properties in terms of yellow index and modulus.

The pH adjusting agent may be employed in an amount of 0.1% by mole to 10% by mole based on the total number of moles of monomers in the polymer solution.

In another embodiment, the step of preparing the polymer solution may further comprise purging with an inert gas. The step of purging with an inert gas may remove moisture, reduce impurities, increase the reaction yield, and impart excellent surface appearance and mechanical properties to the film finally produced.

The inert gas may be at least one selected from the group consisting of nitrogen, helium (He), neon (Ne), argon (Ar), krypton (Kr), xenon (Xe), and radon (Rn), but it is not limited thereto. Specifically, the inert gas may be nitrogen.

The molar ratio of the dianhydride compound to the dicarbonyl compound used to prepare the polymer solution may be 2:98 to 15:85. For example, the molar ratio may be 3:97 to 15:85, 5:95 to 15:85, or 7:93 to 15:85, but it is not limited thereto.

If the dianhydride compound and the dicarbonyl compound are employed at the above molar ratio, it is advantageous for achieving the desired mechanical properties and optical properties of the polyamide-imide film prepared from the polymer solution.

The details on the diamine compound, the dianhydride compound, and the dicarbonyl compound are as described above.

In an embodiment, the organic solvent may be at least one selected from the group consisting of dimethylformamide (DMF), dimethylacetamide (DMAc), N-methyl-2-pyrrolidone (NMP), m-cresol, tetrahydrofuran (THF), and chloroform. The organic solvent employed in the polymer solution may be dimethylacetamide (DMAc), but it is not limited thereto.

Once the polymer solution comprising a polymer resin in an organic solvent has been prepared as described above, a filler dispersion in which a filler has been dispersed is added to the solution.

The filler has an average particle diameter of 110 nm to 180 nm. In addition, the filler is barium sulfate.

The content of the filler is 500 ppm to 2,000 ppm based on the total weight of the solids content of the polymer resin, but it is not limited thereto.

The details on the filler are as described above.

The filler dispersion may further comprise a dispersant.

The dispersant serves to help the filler in the dispersion to be uniformly dispersed in the polymer solution comprising a polymer resin.

In such event, the dispersant is preferably a neutral dispersant.

The content of filler solids contained in the filer dispersion is 10% by weight to 30% by weight.

If the content of the filler contained in the filler dispersion is within the above range, the filler may be uniformly dispersed and appropriately mixed with the polymer solution comprising a polymer resin. In addition, the aggregation of the filler is minimized, no feeling of foreign matter is present on the film surface when a film is prepared, and the optical properties and mechanical properties of the film can be enhanced together.

In addition, the filler dispersion may further comprise a solvent.

The solvent may be an organic solvent. Specifically, it may be at least one selected from the group consisting of dimethylformamide (DMF), dimethylacetamide (DMAc), N-methyl-2-pyrrolidone (NMP), m-cresol, tetrahydrofuran (THF), and chloroform. Preferably, the solvent contained in the filler dispersion may be dimethylacetamide (DMAc), but it is not limited thereto.

Next, the polymer solution comprising the filler dispersion is transferred to a tank (S200).

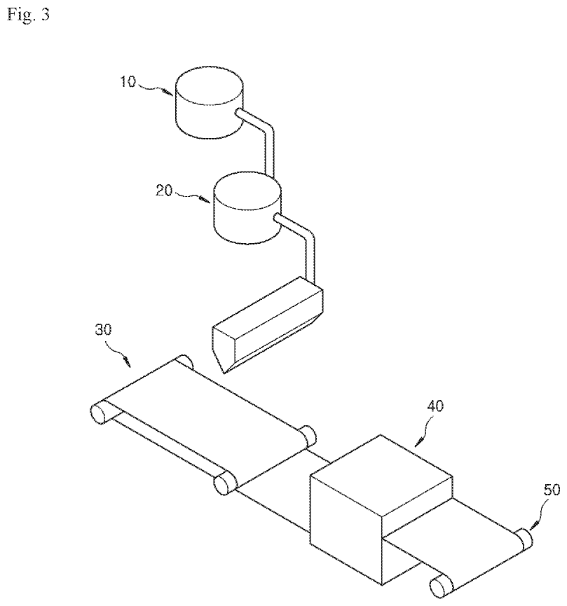

FIG. 3 schematically illustrates process facilities for preparing the polymer film according to an embodiment. Referring to FIG. 3, the polymer solution as described above is prepared in a polymerization apparatus (10), and the polymer solution thus produced is transferred to, and stored in, a tank (20).

Here, once the polymer solution has been prepared, the step of transferring the polymer solution to the tank is carried out without any additional steps. Specifically, the polymer solution prepared in the polymerization apparatus is transferred to, and stored in, the tank without any separate precipitation and redissolution steps for removing impurities. In the conventional process, in order to remove impurities such as hydrochloric acid (HCl) generated during the preparation of a polymer solution, the polymer solution thus prepared is purified through a separate step to remove the impurities, and the purified polymer solution is then redissolved in a solvent. In this case, however, there has been a problem that the loss of the active ingredient increases in the step of removing the impurities, resulting in decreases in the yield.

Accordingly, the preparation process according to an embodiment ultimately minimizes the amount of impurities generated in the step of preparing the polymer solution or properly controls the impurities in the subsequent steps, even if a certain amount of impurities is present, so as not to deteriorate the physical properties of the final film. Thus, the process has an advantage in that a film is produced without separate precipitation or redissolution steps.

The tank (20) is a place for storing the polymer solution before forming it into a film, and its internal temperature may be −20° C. to 20° C.

Specifically, the internal temperature may be −20° C. to 10° C., −20° C. to 5C, −20° C. to 0° C., or 0° C. to 10° C., but it is not limited thereto.

If the internal temperature of the tank (20) is controlled to the above range, it is possible to prevent the polymer solution from deteriorating during storage, and it is possible to lower the moisture content to thereby prevent defects of the film produced therefrom.

The process for preparing a polymer film may further comprise carrying out vacuum degassing of the polymer solution transferred to the tank (20).

The vacuum degassing may be carried out for 30 minutes to 3 hours after depressurizing the internal pressure of the tank to 0.1 bar to 0.7 bar. The vacuum degassing under these conditions may reduce bubbles in the polymer solution. As a result, it is possible to prevent surface defects of the film produced therefrom and to achieve excellent optical properties such as haze.

In addition, the process for preparing a polymer film may further comprise purging the polymer solution transferred to the tank (20) with an inert gas (S300).

Specifically, the purging is carried out by purging the tank with an inert gas at an internal pressure of 1 atm to 2 atm. The nitrogen purging under these conditions may remove moisture in the polymer solution, reduce impurities to thereby increase the reaction yield, and achieve excellent optical properties such as haze and mechanical properties.

The inert gas may be at least one selected from the group consisting of nitrogen, helium (He), neon (Ne), argon (Ar), krypton (Kr), xenon (Xe), and radon (Rn), but it is not limited thereto. Specifically, the inert gas may be nitrogen.

The step of vacuum degassing and the step of purging the tank with an inert gas are performed in a separate step, respectively.

For example, the step of vacuum degassing may be carried out, followed by the step of purging the tank with an inert gas, but it is not limited thereto.

The step of vacuum degassing and/or the step of purging the tank with an inert gas may improve the physical properties of the surface of the polymer film thus produced.

Thereafter, the process may further comprise storing the polymer solution in the tank (20) for 1 hour to 360 hours. Here, the temperature inside the tank may be kept at −20° C. to 20° C.

The process for preparing a polymer film may further comprise extruding and casting the polymer solution in the tank and then drying it to prepare a gel-sheet (S400).

The polymer solution may be cast onto a casting body such as a casting roll or a casting belt.

Referring to FIG. 3, according to an embodiment, the polymer solution may be applied onto a casting belt (30) as a casting body, and it is dried while it is moved to be made into a sheet in the form of a gel.

When the polymer solution is injected onto the belt (30), the injection rate may be 300 g/min to 700 g/min. If the injection rate of the polymer solution satisfies the above range, the gel-sheet can be uniformly formed to an appropriate thickness.

In addition, the casting thickness of the polymer solution may be 200 μm to 700 μm. If the polymer solution is cast to a thickness within the above range, the final film produced after the drying and thermal treatment may have an appropriate and uniform thickness.

As described above, the viscosity of the polymer solution at room temperature may be 100,000 cps to 500,000 cps, for example, 100,000 cps to 400,000 cps, 100,000 cps to 350,000 cps, 150,000 cps to 350,000 cps, or 150,000 cps to 250,000 cps. If the viscosity satisfies the above range, the polymer solution can be cast onto a belt in a uniform thickness without defects.

The polymer solution is cast and then dried at a temperature of 60° C. to 150° C. for 5 minutes to 60 minutes to prepare a gel-sheet. Specifically, the drying may be carried out with hot air at 60° C. to 120° C. for 10 minutes to 50 minutes.

The solvent of the polymer solution is partially or totally volatilized during the drying to prepare the gel-sheet.

The moving speed of the gel-sheet on the casting body at the time of drying may be 0.1 m/min to 15 m/min, for example, 0.5 m/min to 10 m/min, but it is not limited thereto.

The process for preparing a polymer film comprises thermally treating the gel-sheet while it is moved to prepare a cured film (S500).

Referring to FIG. 3, the thermal treatment of the gel-sheet may be carried out by passing it through a thermosetting device (40).

The thermal treatment of the gel-sheet is carried out in a temperature range of 80° C. to 500° C. for 5 minutes to 180 minutes. Specifically, the thermal treatment of the gel-sheet may be carried out in a temperature range of 80° C. to 500° C. at a temperature elevation rate of 2° C./min to 80° C./min for 5 minutes to 150 minutes. More specifically, the thermal treatment of the gel-sheet may be carried out in a temperature range of 80° C. to 300° C. at a temperature elevation rate of 2° C.

According to an embodiment, the gel-sheet may be treated with hot air.

If the thermal treatment is carried out with hot air, the heat may be uniformly supplied. If the heat is not uniformly supplied, satisfactory mechanical properties cannot be achieved. In particular, a satisfactory surface roughness cannot be achieved, which may raise or lower the surface tension too much.

The thermal treatment under these conditions may cure the gel-sheet to have appropriate surface hardness and modulus.

The process for preparing a polymer film comprises cooling the cured film while it is moved (S600).

Referring to FIG. 3, the cooling of the cured film is carried out after it has been passed through the thermosetting device (40). It may be carried out by using a separate cooling chamber (not shown) or by forming an appropriate temperature atmosphere without a separate cooling chamber.

The step of cooling the cured film while it is moved may comprise a first temperature lowering step of reducing the temperature at a rate of 100° C./min to 1,000° C./min and a second temperature lowering step of reducing the temperature at a rate of 40° C./min to 400° C./min.

In such event, specifically, the second temperature lowering step is performed after the first temperature lowering step. The temperature lowering rate of the first temperature lowering step may be faster than the temperature lowering rate of the second temperature lowering step.

For example, the maximum rate of the first temperature lowering step is faster than the maximum rate of the second temperature lowering step. Alternatively, the minimum rate of the first temperature lowering step is faster than the minimum rate of the second temperature lowering step.

If the step of cooling the cured film is carried in such a multistage manner, it is possible to have the physical properties of the cured film further stabilized and to maintain the optical properties and mechanical properties of the film achieved during the curing step more stably for a long period of time.

The moving speed of the gel-sheet and the moving speed of the cured film are the same.

The process for preparing a polymer film comprises winding the cooled cured film using a winder (S700).

Referring to FIG. 3, the cooled cured film may be wound using a roll-shaped winder (50).

In such event, the ratio of the moving speed of the gel-sheet on the belt at the time of drying to the moving speed of the cured film at the time of winding is 1:0.95 to 1:1.40. Specifically, the ratio of the moving speeds may be 1:0.99 to 1:1.20, 1:0.99 to 1:1.10, or 1:1.10 to 1:1.05, but it is not limited thereto.

If the ratio of the moving speeds is outside the above range, the mechanical properties of the cured film may be impaired, and the flexibility and elastic properties may be deteriorated.

In the process for preparing a polymer film, the thickness variation (%) according to the following Relationship 1 may be 3% to 30%. Specifically, the thickness variation (%) may be 5% to 20%, but it is not limited thereto.

Thickness variation (%)=(M1−M2)/M2×100 [Relationship 1]

In Relationship 1, M1 is the thickness (μm) of the gel-sheet, and M2 is the thickness (sm) of the cooled cured film at the time of winding.

The polymer film prepared by the preparation process as described above is excellent in antiblocking characteristics, optical properties, and mechanical properties.

The polymer film may be applicable to various uses that require durability and transparency. For example, the polymer film may be applied to solar cells, semiconductor devices, sensors, and the like, as well as display devices.

The details on the polymer film prepared by the process for preparing a polymer film are as described above.

Hereinafter, the above description will be described in detail by referring to examples. However, these examples are set forth to illustrate the present invention, and the scope of the present invention is not limited thereto.

### EXAMPLE

### Example 1

A 1-liter glass reactor equipped with a temperature-controllable double jacket was charged with dimethylacetamide (DMAc) as an organic solvent at 20° C. under a nitrogen atmosphere. Then, 2,2′-bis(trifluoromethyl)-4,4′-diaminobiphenyl (TFMB) was slowly added thereto for dissolution thereof. Subsequently, 2,2′-bis(3,4-dicarboxyphenyl)hexafluoropropane dianhydride (6FDA) was slowly added thereto, and the mixture was stirred for 1 hour. Then, terephthaloyl chloride (TPC) and isophthaloyl chloride (IPC) were added, followed by stirring for 1 hour, thereby preparing a polymer solution.

Subsequently, a barium sulfate dispersion (solids content: 18.2% by weight and organic solvent: DMAc) was added to the polymer solution and stirred.

The polymer solution thus obtained was coated onto a glass plate and then dried with hot air at 80° C. for 30 minutes. It was detached from the glass plate, fixed to a pin frame, and thermally treated in a temperature range of 80° C. to 300° C. at a temperature elevation rate of 2° C./min to obtain a polymer film having a thickness of 50 m.

As to the contents of the diamine compound (TFMB), dianhydride compound (6FDA), and the dicarbonyl compounds (TPC and IPC), the molar ratios thereof are shown in Table 1. The number of moles of the dianhydride compound and the dicarbonyl compounds is based on 100 moles of the diamine compound.

In addition, the type, refractive index, and content of the filler are shown in Table 1.

### Examples 2 to 6 and Comparative Examples 1 to 4

Films were prepared in the same manner as in Example 1, except that the types and contents of the respective reactants, those of the filler, and the like were changed as shown in Table 1 below.

### Evaluation Example

The films prepared in Examples 1 to 6 and Comparative Examples 1 to 4 were each measured and evaluated for the following properties. The results are shown in Table 2 below.

### Evaluation Example 1: Maximum Coefficient of Static Friction and Coefficient of Kinetic Friction

The maximum coefficient of static friction and the coefficient of kinetic friction were measured using a friction coefficient tester (QM110CF) manufactured by QMESYS under the conditions of a vertical load of 205 g, a film size of 63.5 mm×63.5 mm, and a measurement speed of 150 mm/min according to ASTM D1894.

### Evaluation Example 2: Measurement of Transmittance and Haze

The transmittance at 550 nm was measured using a haze meter NDH-5000W manufactured by Nippon Denshoku Kogyo.

### Evaluation Example 3: Measurement of Yellow Index

The yellow Index (YI) was measured with a spectrophotometer (UltraScan PRO, Hunter Associates Laboratory) using a CIE colorimetric system.

### Evaluation Example 4: Measurement of Modulus

A sample was cut out by at least 5 cm in the direction perpendicular to the main shrinkage direction of the film and by 10 cm in the main shrinkage direction. It was fixed by the clips disposed at intervals of 5 cm in a universal testing machine UTM 5566A of Instron. A stress-strain curve was obtained until the sample was fractured while it was stretched at a rate of 5 mm/min at room temperature. The slope of the load with respect to the initial strain on the stress-strain curve was taken as the modulus (GPa).

### Evaluation Example 5: Observation of Film Surface

The surface of the prepared film was observed by the naked eyes.

In such event, if no aggregations were observed on the film surface, it was ⊚. If slight aggregations were observed, it was ◯. If remarkable aggregations were observed, it was.

TABLE 1

| | | | | | | | C. Ex. | C. Ex. | C. Ex. | C. Ex. |
|---|---|---|---|---|---|---|---|---|---|---|
| | Ex. 1 | Ex. 2 | Ex. 3 | Ex. 4 | Ex. 5 | Ex. 6 | 1 | 2 | 3 | 4 |
| Diamine | TFMB | TFMB | TFMB | TFMB | TFMB | TFMB | TFMB | TFMB | TFMB | TFMB |
| | 100 | 100 | 100 | 100 | 100 | 100 | 100 | 100 | 100 | 100 |
| Dianhydride | 6FDA | 6FDA | 6FDA | 6FDA | 6FDA | 6FDA | 6FDA | 6FDA | 6FDA | 6FDA |
| | 7 | 7 | 7 | 20 | 7 | 7 | 7 | 7 | 7 | 7 |
| Dicarbonyl | TPC 71 | TPC 71 | TPC 71 | TPC 58 | TPC 71 | TPC 71 | TPC 71 | TPC 71 | TPC 71 | TPC 71 |
| compound | IPC 22 | IPC 22 | IPC 22 | IPC 22 | IPC 22 | IPC 22 | IPC 22 | IPC 22 | IPC 22 | IPC 22 |
| Imide:amide | 7:93 | 7:93 | 7:93 | 20:80 | 7:93 | 7:93 | 7:93 | 7:93 | 7:93 | 7:93 |
| Thickness | 50 | 50 | 50 | 50 | 50 | 50 | 50 | 50 | 50 | 50 |
| (μm) | | | | | | | | | | |
| Film | 1.64 | 1.62 | 1.65 | 1.64 | 1.63 | 1.64 | 1.64 | 1.64 | 1.63 | 1.65 |
| refractive | | | | | | | | | | |
| index (n₁) | | | | | | | | | | |
| Filler type | BaSO₄ | BaSO₄ | BaSO₄ | BaSO₄ | BaSO₄ | CaCO₃ | BaSO₄ | SiO₂ | SiO₂ | TiO₂ |
| Filler | 1.63 | 1.63 | 1.63 | 1.63 | 1.63 | 1.59 | 1.63 | 1.45 | 1.45 | 2.48 |
| refractive | | | | | | | | | | |
| index (n₂) | | | | | | | | | | |
| Filler | 500 | 1000 | 2000 | 1000 | 4000 | 1000 | 100 | 1000 | 2000 | 1000 |
| content | | | | | | | | | | |
| (ppm) | | | | | | | | | | |

TABLE 2

| | | | | | | | C. Ex. | C. Ex. | C. Ex. | C. Ex. |
|---|---|---|---|---|---|---|---|---|---|---|
| | Ex. 1 | Ex. 2 | Ex. 3 | Ex. 4 | Ex. 5 | Ex. 6 | 1 | 2 | 3 | 4 |
| Δn value | 0.01 | 0.01 | 0.02 | 0.01 | 0 | 0.05 | 0.01 | 0.19 | 0.18 | 0.83 |
| n₁₂ value | 0.610 | 0.617 | 1.212 | 0.610 | 0.000 | 3.049 | 0.610 | 11.585 | 11.043 | 50.303 |
| NC value | 10 | 20 | 60 | 20 | 40 | 60 | 2 | 200 | 380 | 840 |
| Maximum | 0.52 | 0.505 | 0.483 | 0.510 | 0.397 | 0.372 | Out of | 0.525 | 0.503 | 0.361 |
| coefficient | | | | | | | range | | | |
| of static | | | | | | | | | | |
| friction | | | | | | | | | | |
| Coefficient | 0.494 | 0.48 | 0.461 | 0.472 | 0.381 | 0.350 | Out of | 0.502 | 0.481 | 0.340 |
| of kinetic | | | | | | | range | | | |
| friction | | | | | | | | | | |
| Transmit- | 89.1 | 89.2 | 89 | 89.0 | 88.9 | 88.5 | 89.2 | 89.0 | 89.0 | 88.3 |
| tance (%) | | | | | | | | | | |
| Haze (%) | 0.5 | 0.5 | 0.5 | 0.5 | 1.2 | 1.2 | 0.4 | 1.2 | 1.5 | 3.8 |
| Optical slip | 0.247 | 0.24 | 0.231 | 0.236 | 0.457 | 0.42 | — | 0.602 | 0.722 | 1.292 |
| index (OS) | | | | | | | | | | |
| Yellow | 3 | 2.8 | 2.5 | 2.4 | 3.0 | 3.2 | 2.6 | 3.4 | 3.8 | 4.2 |
| index | | | | | | | | | | |
| Modulus | 6.2 | 6.3 | 6.4 | 4.5 | 6.1 | 4.8 | 6.3 | 6.2 | 6.1 | 5.1 |
| (GPa) | | | | | | | | | | |
| Film surface | ⊚ | ⊚ | ⊚ | ⊚ | ◯ | X | ⊚ | ◯ | ◯ | X |

As can be seen from Tables 1 and 2 above, the polymer films of Examples 1 to 6 had an optical slip index of less than 0.5. Thus, they had both enhanced optical properties and enhanced slip properties.

In addition, the polymer films of Examples 1 to 4 had a maximum coefficient of static friction and a coefficient of kinetic friction of 0.520 or less and 0.500 or less, respectively. Thus, they were excellent in antiblocking properties and optical properties in terms of a haze of 1% or less.

Here, the antiblocking properties indicate a property of sliding smoothly at the interface in contact with the film. The better the antiblocking properties, the better the sliding performance and windability in the preparation process. That is, if the antiblocking properties are excellent, there are no defects on the film since it can be smoothly wound and unwound without significant friction between the films.

Further, the polymer films of Examples 1 to 4 had a clean surface without aggregation or precipitation of the filler and at least a certain level of such characteristics as transmittance and modulus, let alone the friction coefficients and haze as described above, so that the film can be applied to a front panel or a display device without any problems.

In contrast, the polymer films of Comparative Examples 1 to 4 were relatively high in the maximum coefficient of static friction or the coefficient of kinetic friction as compared with the films of Examples 1 to 4, resulting in a deterioration in the antiblocking properties, or they had poor optical properties in terms of a haze exceeding 1%.

In addition, the polymer films of Comparative Examples 1 to 4 did not have a clean surface since the aggregation or precipitation of particles was visually observed. In Comparative Example 1, both the maximum coefficient of static friction and the coefficient of kinetic friction were too high, resulting in defects in the film during winding thereof. Thus, it was not suitable for application to a subsequent process.

### REFERENCE NUMERALS OF THE DRAWINGS

10: polymerization apparatus
20: tank
30: belt
40: thermosetting device
50: winder
100: polymer film
101: first side
102: second side
200: functional layer
300: front panel
400: display unit
500: adhesive layer

1. A polymer film for a display, which comprises a polymer resin selected from the group consisting of a polyamide-based resin and a polyimide-based resin and a filler and which has an optical slip index (OS) represented by the following Equation 1 of less than 0.5:
$$OS = \frac{Hz}{1 \%} \times CKF \qquad [ Equation 1 ]$$
in Equation 1, Hz is the haze (%) of the polymer film, and CKF is the coefficient of kinetic friction of the polymer film.

2. The polymer film for a display of claim 1, which has an optical slip index of 0.01 to 0.40.

3. The polymer film for a display of claim 1, which has a maximum coefficient of static friction of 0.380 to 0.520 and a coefficient of kinetic friction of 0.350 to 0.500.

4. The polymer film for a display of claim 3, which has a maximum coefficient of static friction of 0.400 to 0.520 and a coefficient of kinetic friction of 0.380 to 0.500.

5. The polymer film for a display of claim 1, which has an n₁₂ of the following Equation 2 of 3 or less:
$${n}_{12} = \frac{\vert n 1 - n 2 \vert}{n 1} \times 100 \qquad [ Equation 2 ]$$
in Equation 2, n₁ is the refractive index of the polymer film, and n₂ is the refractive index of the filler.

6. The polymer film for a display of claim 1, which has a Δn of the following Equation 3 of 0.1 or less:
Δn=|n₁−n₂| [Equation 3]
in Equation 3, n₁ is the refractive index of the polymer film, and n₂ is the refractive index of the filler.

7. The polymer film for a display of claim 1, which has a refractive index (n₁) of 1.55 to 1.75.

8. The polymer film for a display of claim 1, wherein the filler has a refractive index (n₂) of 1.55 to 1.75.

9. The polymer film for a display of claim 1, which has an NC of the following Equation 4 of 5 to 150:
$$NC = ( \vert {n}_{1} - {n}_{2} \vert + 0.01 ) \times \frac{FC}{1 ppm} \qquad [ Equation 4 ]$$
in Equation 4, n₁ is the refractive index of the polymer film, n₂ is the refractive index of the filler, and FC is the content (ppm) of the filler based on the total weight of the solids content of the polymer resin.

10. The polymer film for a display of claim 1, wherein the filler is barium sulfate.

11. The polymer film for a display of claim 1, wherein the average particle diameter of the filler is 110 to 180 nm.

12. The polymer film for a display of claim 1, wherein the content of the filler is 500 ppm to 2,000 ppm based on the total weight of the solids content of the polymer resin.

13. The polymer film for a display of claim 1, wherein the polymer resin comprises an imide-based repeat unit and an amide-based repeat unit at a molar ratio of 2:98 to 15:85.

14. The polymer film for a display of claim 1, which has a haze of 1% or less.

15. The polymer film for a display of claim 1, which has a transmittance of 80% or more, a yellow index of 3 or less, and a modulus of 5 GPa or more.

16. A front panel for a display, which comprises a polymer film and a functional layer,
wherein the polymer film comprises a polymer resin selected from the group consisting of a polyamide-based resin and a polyimide-based resin and a filler and has an optical slip index (OS) represented by the following Equation 1 of less than 0.5:
$$OS = \frac{Hz}{1 \%} \times CKF \qquad [ Equation 1 ]$$
in Equation 1, Hz is the haze (%) of the polymer film, and CKF is the coefficient of kinetic friction of the polymer film.

17. A display device, which comprises a display unit; and a front panel disposed on the display unit,
wherein the front panel comprises a polymer film, and
the polymer film comprises a polymer resin selected from the group consisting of a polyamide-based resin and a polyimide-based resin and a filler and has an optical slip index (OS) represented by the following Equation 1 of less than 0.5:
$$OS = \frac{Hz}{1 \%} \times CKF \qquad [ Equation 1 ]$$
in Equation 1, Hz is the haze (%) of the polymer film, and CKF is the coefficient of kinetic friction of the polymer film.

18. A process for preparing the polymer film of claim 1, which comprises:
preparing a solution comprising a polymer resin selected from the group consisting of a polyamide-based resin and a polyimide-based resin in an organic solvent;
adding a filler dispersion in which a filler is dispersed to the solution;
charging the solution comprising the filler dispersion into a tank;
extruding and casting the solution in the tank and then drying it to prepare a gel sheet; and
thermally treating the gel sheet.

19. The process of claim 18 for preparing the polymer film, wherein the filler is barium sulfate.

20. The process of claim 18 for preparing the polymer film, wherein the filler solids content of the filler contained in the filer dispersion is 10% by weight to 30% by weight.
